(19) United States
(12) Patent Application Publication
(10) Pub. No.: US 2014/0040297 A1
(43) Pub. Date: Feb. 6, 2014

(54) KEYWORD EXTRACTION

(71) Applicants: Mehmet Kivanc Ozonat, San Jose, CA (US); Claudio Bartolini, Palo Alto, CA (US)

(72) Inventors: Mehmet Kivanc Ozonat, San Jose, CA (US); Claudio Bartolini, Palo Alto, CA (US)

(21) Appl. No.: 13/563,030

(22) Filed: Jul. 31, 2012

(51) Int. Cl. G06F 17/30

(52) U.S. Cl. 707/758; 707/E17.014

(57) ABSTRACT

Methods, systems, and computer-readable and executable instructions are provided for keyword extraction. A method for keyword extraction can include extracting a number of keywords from content inside an enterprise social network utilizing pattern recognition, constructing a semantics graph based on the number of keywords, and determining content themes within the enterprise social network based on the constructed semantics graph.

### BACKGROUND

An enterprise social network can be used to share knowledge, learn from others' experiences, and search for content relevant to a particular business. Participants may have an option to tag and thematize content within the network to facilitate content search and retrieval.

### BRIEF DESCRIPTION OF THE DRAWINGS

FIG. 1 is a block diagram illustrating an example of a method for keyword extraction according to the present disclosure.

FIG. 2 is a block diagram illustrating an example of a method for keyword extraction according to the present disclosure.

FIG. 3 is a block diagram illustrating an example semantics graph according to the present disclosure.

FIG. 4 illustrates an example computing device according to the present disclosure.

### DETAILED DESCRIPTION

An enterprise social network (e.g., enterprise social platform) can include, for example, an environment for participants (e.g., employees of a company) to share their opinions, knowledge, and subject-matter expertise on particular topics. An enterprise social network can allow for users to learn from others' experience and search for content relevant to particular company divisions. Participants can, for example, post entries, link their entries to a company's internal and external websites, and comment and vote on each others' posts.

An enterprise social network can include unstructured content, so participants may need to search for content in order to retrieve it. To address this, social networks may allow participants to tag and thematize content; however, enterprise social network participants may not always tag and thematize their content, and when they do, the tags and themes can be misleading and/or incomplete.

Keyword extraction (e.g., keyword and tag extraction) can include a tagging and themetization method that can support search and retrieval capabilities for a social network. Keyword and key phrase extraction can include extracting words and phrases (e.g., two or more words) based on term co-occurrences that can result in increased search and retrieval accuracy, as well as extraction accuracy, over other techniques, for example.

Examples of the present disclosure may include methods, systems, and computer-readable and executable instructions and/or logic. An example method for keyword extraction can include extracting a number of keywords from content inside an enterprise social network utilizing pattern recognition, constructing a semantics graph based on the number of keywords, and determining content themes within the enterprise social network based on the constructed semantics graph.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of” an element and/or feature can refer to one or more of such elements and/or features.

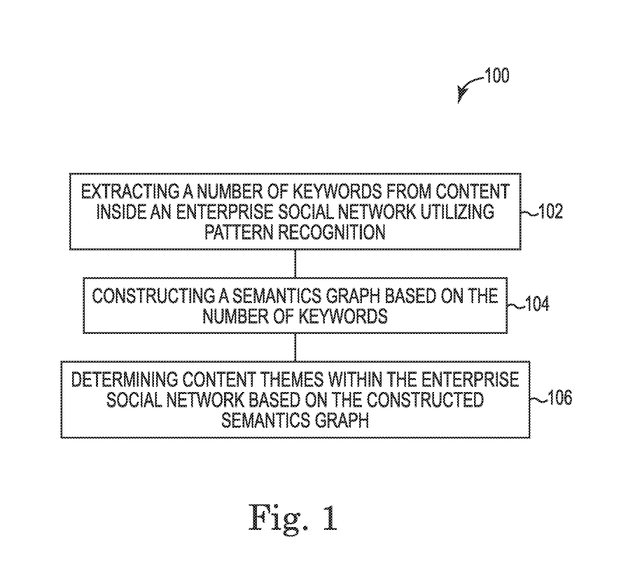

FIG. 1 is a block diagram illustrating an example of a method 100 for keyword extraction according to the present disclosure. At 102, a number of keywords are extracted from content inside an enterprise social network (e.g., enterprise social network platform) utilizing pattern recognition (e.g., assigning a label to a given input value).

Keyword extraction can include extracting (e.g., automatically extracting) structured information from unstructured and/or semi-structured computer-readable documents. Keyword extraction techniques can be based on the term frequency/inverse document frequency (TD/IDF) method. The TD/IDF method compares word frequencies in a word repository (e.g., keyword repository) with word frequencies in sample text; if the frequency of a word in the sample text is higher as compared to its frequency in the repository, (e.g., meets and/or exceeds some threshold) the word is extracted and/or designated as a keyword.

However, an enterprise social network and a thread within the network may contain a limited number of sentences and words. This can result in an inability to obtain reliable statistics based on word frequencies. In an enterprise social network, a number of relevant words may appear only once in the thread, making them indistinguishable from other, less relevant words of the thread, for example.

Utilizing a vector of keywords can result in increasingly accurate keyword extraction. For example, a vector of keywords can be formed in a repository of forum threads, and a binary features vector for each thread can be generated. If the ith repository keyword appears in the thread, the ith element of the thread's feature vector is 1, and if the keyword does not appear in the thread, the ith element of the thread's feature vector is 0, for example. A number of different approaches can be used to generate keywords in a given repository.

In some examples, when generating keywords, stop words (e.g., if, and, we, etc.) can be filtered from a repository, and a vector of keywords can be the set of all remaining distinct repository words. In a number of embodiments, only stop words are filtered from the repository.

In some embodiments of the present disclosure, the TF/IDF method can be applied to the entire repository by comparing the word frequencies in the repository with word frequencies in the English language when generating keywords. For example, if the frequency of a word is higher in the repository (e.g., meets and/or exceeds some threshold) in comparison to the English language (e.g., and/or other applicable language), the word can be taken the word as a keyword.

In some examples, generating keywords can include utilizing term co-occurrence. A term co-occurrence method can include extracting keywords from a repository without comparing the repository frequencies with language frequencies. For example, let N denote a number of all distinct words in the repository of forum threads. An N×M co-occurrence matrix can be constructed, where M is a pre-selected integer with M<N. In an example, M can be 500. Distinct words (e.g., all distinct words) can be indexed by n, (e.g., 1≦n≦N). The most frequently observed M words can be indexed in the repository by m such that 1≦m≦M. The (n:m) element (e.g., nth row and the mth column) of the N×M co-occurrence matrix counts the number of times the word n and the word m occur together.

In an example, the word “wireless” can have an index n, the word “connection” can have an index m, and “wireless” and “connection” can occur together 218 times in the repository; therefore, the (n:m) element of the co-occurrence matrix is 218. If the word n appears independently from the words 1≦m≦M (e.g., the frequent words), the number of times the word n co-occurs with the frequent words is similar to the unconditional distribution of occurrence of the frequent words. On the other hand, if the word n has a semantic relation to a particular set of frequent words, then the co-occurrence of the word n with the frequent words is greater than the unconditional distribution of occurrence the frequent words. The unconditional probability of a frequent word m can be denoted as the expected probability pₘ, and the total number of co-occurrences of the word n and frequent terms can be denoted as cₙ. Frequency of co-occurrence of the word n and the word m can be denoted as freq(n;m). The statistical value of x² can be defined as:

$${x}^{2} ( n ) = {\sum }_{1 \leq m \leq M}^{ } \frac{freq ( n , m ) - {N}_{n} {p}_{m}}{{n}_{m} {p}_{m}} .$$

The number of extracted keywords can automatically be assigned tags with the intent of providing search and retrieval capability within the enterprise social network. A repository of the keywords (and/or keyword tags) can be built automatically, and the keywords can be automatically assigned their tags utilizing the repository.

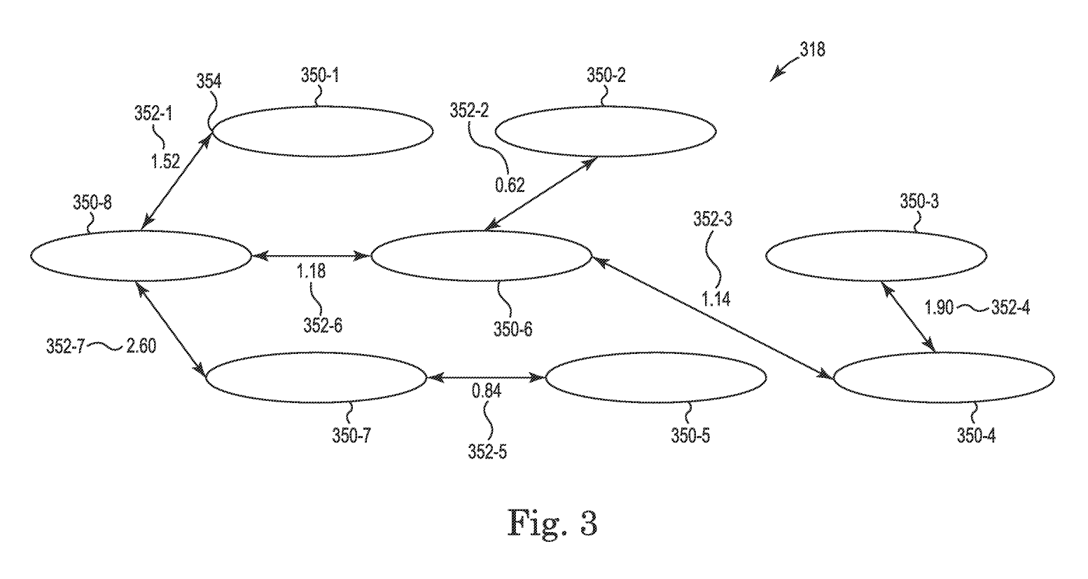

At 104, a semantics graph is constructed based on the number of keywords. The semantics graph, which will be further discussed herein with respect to FIG. 3, can include a representation of semantic relationships between concepts (e.g., keywords, keyword tags). These relationships can be used to cluster keywords into themes, for example.

At 106, content themes are determined within the enterprise social network based on the constructed semantics graph. Content can include, for example the keywords extracted, and/or other words and terms within the enterprise social network. In some examples, determining content themes can include finding clusters within the semantics graph in which the number of keywords appear most often. The content can be clustered based on relationships within the content, and sections (e.g., frequent terms, among others) of the content can be summarized with a theme.

Content can be clustered, for example, if the frequent words m₁ and m₂ co-occur frequently with each other and/or the frequent words m₁ and m₂ have a same and/or similar distribution of co-occurrence with other words. To quantify the first condition of m₁ and m₂ co-occurring frequently, the mutual information between the occurrence probability of m₁ and m₂ can be used. To quantify the second condition of m₁ and m₂ having a similar distribution of co-occurrence with other words, the Kullback-Leibler divergence between the occurrence probability of m₁ and m₂ can be used.

A Gauss mixture vector quantization (GMVQ) can be used to design a hierarchical clustering model. For example, consider the training set {zᵢ, 1≦i≦N} with its (not necessarily Gaussian) underlying distribution f in the form f(Z)=Σₖpₖfₖ(Z). The goal of GMVQ may be to find the Gaussian mixture distribution, g, that minimizes the distance between f and g. A Gaussian mixture distribution g that can minimize this distance (e.g., minimizes in the Lloyd-optimal sense) can be obtained iteratively with the particular updates at each iteration.

Given μₖ, Σₖ, and pₖ for each cluster k, each zᵢ can be assigned to the cluster k that minimizes

$$\frac{1}{2} log ( \vert {\sum }_{k}^{ } \vert + \frac{1}{2} {( {z}_{i} - {μ}_{k} )}^{T} {\sum }_{k}^{- 1} ( {z}_{i} - {μ}_{k} ) - log {p}_{k} ,$$

where |Σₖ| is the determinant of Σₖ.

Given the cluster assignments, μₖ, Σₖ, and pₖ can be set as:

$${μ}_{k} = \frac{1}{‖ {S}_{k} ‖} {\sum }_{{z}_{i} ∈ = {S}_{k}}^{ } {z}_{i} , \\ {\sum =}_{k}^{ } \frac{1}{‖ {S}_{k} ‖} {\sum }_{i}^{ } ( {z}_{i} - {μ}_{k} ) {( {z}_{i} - {μ}_{k} )}^{T} , \\ and$$

$${p}_{k} = \frac{‖ {S}_{k} ‖}{N} ,$$

where Sₖ is the set of training vectors zᵢ assigned to cluster k, and ∥Sₖ∥ is the cardinality of the set.

A Breiman, Friedman, Olshen, and Stone (BFOS) model can be used to design a hierarchical (e.g., tree-structured) extension of GMVQ. The BFOS model may require each node of a tree to have two linear functionals such that one of them is monotonically increasing and the other is monotonically decreasing. Toward this end, a QDA distortion of any subtree, T, of a tree can be viewed as a sum of two functionals, μ₁ and μ₂, such that:

$${μ}_{1} ( T ) = \frac{1}{2} {\sum }_{k ∈ T}^{ } {l}_{k} log ( \vert {\sum }_{k}^{ } \vert + \frac{1}{N} {\sum }_{k ∈ T}^{ } {\sum }_{{z}_{i} ∈ {S}_{k}}^{ } \frac{1}{2} {( {z}_{i} - {μ}_{k} )}^{T} {\sum }_{k}^{- 1} ( {z}_{i} - {μ}_{k} ) , \\ and \\ {μ}_{2} ( T ) = - {\sum }_{k ∈ T}^{ } {p}_{k} log {p}_{k} ,$$

where kεT denotes the set of clusters (e.g., tree leaves) of the subtree T.

A magnitude of μ₂/μ₁ can increase at each iteration. Pruning can be terminated when the magnitude μ₂/μ₁ of reaches A, resulting in the subtree minimizing μ₁+λμ₂.

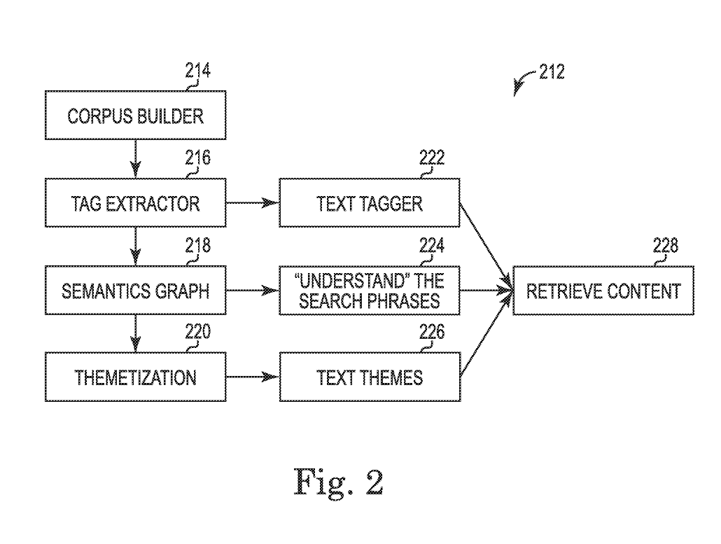

FIG. 2 is a block diagram illustrating an example of a method 212 for keyword extraction according to the present disclosure. At 214, internal websites can be crawled (e.g., by a “corpus builder”) to build a corpus (e.g., structured set of texts), for example. In some embodiments, a seed website for particular lines of business can be used in website crawling. A seed website can be viewed as a main webpage for a corresponding business line, and it can describe a corresponding business line with links to related sites, for example. Starting from the seed sites, crawlers can retrieve internal websites, external websites, and/or content and document management platforms. The retrieved content constitutes the corpus text.

At 216, a tag and/or tags (e.g., a non-hierarchical keyword or term assigned to a piece of information, word, and/or keyword) are extracted, meaning words and phrases (e.g., two or more words) relevant to a domain of interest are determined. The tags can be automatically extracted from the content retrieved by the corpus builder. Tags can be extracted using pattern recognition, which can increase accuracy over other tag extraction models, such as, for example, term frequency/inverse document frequency (TF/IDF).

The TF/IDF technique can discover words and phrases that occur frequently in the corpus and rarely outside the corpus. However, in some examples of the present disclosure, the higher frequency of occurrence of a phrase does not necessarily indicate that the phrase is more relevant, or vice versa. For instance, the phrase “new opportunities” may occur more frequently than the phrase “application rationalization” in a corpus, even though application rationalization is an actual service offering by the company.

Tag extraction by pattern recognition can include a starting assumption that focus (e.g., important, critical, etc.) words and phrases are more likely to occur inside structures such as titles, sub-titles, lists, tables, and/or link descriptors, for example. In response to the assumption, pattern recognition models (e.g., algorithms) can be designed to automatically discover and extract the members of the structures from the corpus content.

Pattern recognition techniques can also be applied to discover which section(s) of a given content are more likely to represent the content topics. For instance, if the content is an HTML page, it may be desired to seek to differentiate main sections from side-bars, as the side-bars may be less likely to be of relevance. Once the members of titles, sub-titles, lists, tables and link descriptors are identified, co-occurrence based techniques, as described previously herein with respect to FIG. 1, can be used to extract the tags in the corpus.

At 218, a semantic graph is built. The semantics graph, as will be further discussed herein with respect to FIG. 3, is a graph of relations between the tags. For example, if phrases u and v relate to similar services lines and/or if they frequently appear in the same titles, lists, and tables, the semantic distance between u and v can be made smaller than if the phrases were unrelated. Using the semantics graph, a minimum number of web links to reach from each seed page to each corpus page on which the phrase u appears can be determined, and from this, it can be deduced to which service lines u is most related. The procedure can be repeated for the phrase v, and it can be discovered whether u and v relate to similar service lines, for example

Tagging can be accompanied by thematization at 220. For example, in some embodiments, tagging by itself may not provide a desired insight about the content. The content can be thematized, meaning each section of the content can be summarized with a theme. In order to progress from tags to themes, the semantic graph is clustered into themes.

To cluster the graph, it can be coarsened by iteratively finding a matching of the graph, and collapsing each set of matched nodes into one node. The coarsened graph can be partitioned by computing a small edge-cut bisection of the coarse graph such that each part contains approximately half of the edge weights of the original graph. The partitioned graph can be partitioned back to the original graph to complete the cluster.

Content in the enterprise social network (e.g., plain text, HTML page, e-mail message, etc.) can be assigned tags at 222 by matching n-tuples in the texts by the tags discovered in the tag extractor stage at 216. The content can be themetized at 226 by finding the graph clusters in which the assigned tags appear most often. When a participant enters a search phrase in a search box in the enterprise social network, the semantic of the inputted search phrase can be “understood” at 224 through the semantics graph constructed at 218, and the relevant content can be retrieved at 228.

For example, a search request including an input phrase can be received regarding the enterprise social network. Utilizing the semantics graph, semantics of the input phrase can be determined, and content relevant to the input phrase can be retrieved from within the enterprise social network.

FIG. 3 is a block diagram illustrating an example semantics graph 318 according to the present disclosure. As noted above, nodes (e.g., nodes 350-1, . . . , 350-8) of the graph 318 are the tags, while the edges (e.g., edge 354) connecting the nodes have weights (e.g., weights 352-1, . . . , 352-7), representing distances between the tags. A smaller distance between two tags indicates that the two tags are more highly related to each other. For example, tags 350-2 and 350-6, with a weight 352-2 between them of 0.62 are more closely related to one another than tag 350-6 and tag 350-4 with a weight 352-3 of 1.14 between them.

A keyword extraction system can be integrated into an enterprise social network and can address an issue of understanding the meaning of tags in their accepted meaning within a company. For instance, as FIG. 3 illustrates, a concept such as one tagged at 350-6 can be related to other concepts such as one tagged at 350-8 and 350-2 while other methods may relate it to concepts not applicable and/or relevant to a particular company's business and/or business focus.

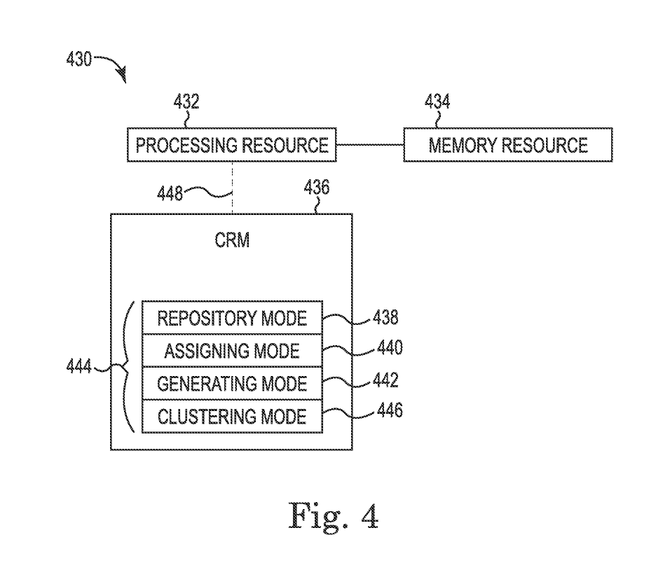

FIG. 4 illustrates an example computing device 430 according to an example of the present disclosure. The computing device 430 can utilize software, hardware, firmware, and/or logic to perform a number of functions.

The computing device 430 can be a combination of hardware and program instructions configured to perform a number of functions. The hardware, for example can include one or more processing resources 432, computer-readable medium (CRM) 436, etc. The program instructions (e.g., computer-readable instructions (CRI) 444) can include instructions stored on the CRM 436 and executable by the processing resources 432 to implement a desired function (e.g., extracting keywords from an enterprise social network, etc.).

CRM 436 can be in communication with a number of processing resources of more or fewer than 432. The processing resources 432 can be in communication with a tangible non-transitory CRM 436 storing a set of CRI 444 executable by one or more of the processing resources 432, as described herein. The CRI 444 can also be stored in remote memory managed by a server and represent an installation package that can be downloaded, installed, and executed. The computing device 430 can include memory resources 434, and the processing resources 432 can be coupled to the memory resources 434.

Processing resources 432 can execute CRI 444 that can be stored on an internal or external non-transitory CRM 436. The processing resources 432 can execute CRI 444 to perform various functions, including the functions described in FIGS. 1-3.

The CRI 444 can include a number of modules 438, 440, 442, and 446. The number of modules 438, 440, 442, and 446 can include CRI 444 that when executed by the processing resources 432 can perform a number of functions.

The number of modules 438, 440, 442, and 446 can be sub-modules of other modules. For example, the repository module 438 and the assigning module 440 can be sub-modules and/or contained within a single module. Furthermore, the number of modules 438, 440, 442, and 446 can comprise individual modules separate and distinct from one another.

A repository module 438 can comprise CRI 444 and can be executed by the processing resources 432 to automatically build a repository of keyword tags. An assigning module 440 can comprise CRI 444 and can be executed by the processing resources 432 to automatically assign a number of keyword tags from within the repository to a number of keywords within content received from an enterprise social network and extract the number of keyword tags.

A generating module 442 can comprise CRI 444 and can be executed by the processing resources 432 to generate a semantics graph that includes relationships between each of the assigned number of keyword tags. A clustering module 446 can comprise CRI 444 and can be executed by the processing resources 432 to cluster sections of the received content into themes based on the semantics graph.

In a number of embodiments, a system for extracting keywords can include, for example, a corpus builder module configured to retrieve enterprise social network content, a tag extractor module configured to determine a number of words relevant to a domain of interest, tag the number of words, and automatically extract each of the tags from the retrieved content, a semantics graph builder module configured to build a semantics graph that includes a relationship between each of the tags, and a thematization module configured to cluster the semantics graph into themes.

In some embodiments, a system for extracting keywords can include, for example, a computation module configured to compute a minimum number of web links to reach from a seed page to each corpus page on which a number of words appears and deducing to which business line of a company each of the number of words is most related.

A non-transitory CRM 436, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 436 can be integral, or communicatively coupled, to a computing device, in a wired and/or a wireless manner. For example, the non-transitory CRM 436 can be an internal memory, a portable memory, a portable disk, or a memory associated with another computing resource (e.g., enabling CRIs 444 to be transferred and/or executed across a network such as the Internet).

The CRM 436 can be in communication with the processing resources 432 via a communication path 448. The communication path 448 can be local or remote to a machine (e.g., a computer) associated with the processing resources 432. Examples of a local communication path 448 can include an electronic bus internal to a machine (e.g., a computer) where the CRM 436 is one of volatile, non-volatile, fixed, and/or removable storage medium in communication with the processing resources 432 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 448 can be such that the CRM 436 is remote from the processing resources, (e.g., processing resources 432) such as in a network connection between the CRM 436 and the processing resources (e.g., processing resources 432). That is, the communication path 448 can be a network connection. Examples of such a network connection can include a local area network (LAN), wide area network (WAN), personal area network (PAN), and the Internet, among others. In such examples, the CRM 436 can be associated with a first computing device and the processing resources 432 can be associated with a second computing device (e.g., a Java® server). For example, a processing resource 432 can be in communication with a CRM 436, wherein the CRM 436 includes a set of instructions and wherein the processing resource 432 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A computer-implemented method for keyword extraction, comprising:
extracting a number of keywords from content inside an enterprise social network utilizing pattern recognition;
constructing a semantics graph based on the number of keywords; and
determining content themes within the enterprise social network based on the constructed semantics graph.

2. The computer-implemented method of claim 1, wherein determining content themes further comprises finding clusters within the semantics graph in which the number of keywords appear most often.

3. The computer-implemented method of claim 1, wherein extracting a number of keywords further comprises:
forming a vector of keywords in a repository of forum threads; and
generating a binary features vector for each thread.

4. The computer-implemented method of claim 1, further comprising:
receiving a search request for the enterprise social network, the search request including an input phrase;
determining semantics of the input phrase utilizing the semantics graph; and
retrieving content from within the enterprise social network relevant to the input phrase.

5. A non-transitory computer-readable medium storing a set of instructions for keyword extraction executable by a processing resource to:
automatically build a repository of keyword tags;
automatically assign a number of keyword tags from within the repository to a number of keywords within content received from an enterprise social network and extract the number of keyword tags;
generate a semantics graph that includes relationships between each of the assigned number of keyword tags; and
cluster sections of the received content into themes based on the semantics graph.

6. The non-transitory computer-readable medium of claim 5, wherein the instructions executable to automatically assign a number of keyword tags are further executable to match n-tuples in the content by the tags discovered during keyword tag extraction.

7. The non-transitory computer-readable medium of claim 5, wherein the instructions executable to extract the number of keyword tags include instructions executable to filter stop words from the repository and utilize remaining repository words as keywords.

8. The non-transitory computer-readable medium of claim 5, wherein the instructions executable to extract the number of keyword tags include instructions executable to compare a word frequency in the repository with a word frequency in a particular language.

9. The non-transitory computer-readable medium of claim 8, wherein the instructions executable to extract the number of keyword tags include instructions executable to designate a word as a keyword if the frequency exceeds a frequency threshold in the repository as compared to the particular language.

10. The non-transitory computer-readable medium of claim 5, wherein the instructions executable to extract the number of keyword tags include instructions executable to extract the keyword tags utilizing term co-occurrence.

11. A system, comprising:
a memory resource;
a processing resource coupled to the memory resource to implement:
a corpus builder module configured to retrieve enterprise social network content;
a tag extractor module configured to determine a number of words relevant to a domain of interest, tag the number of words, and automatically extract each of the tags from the retrieved content;
a semantics graph builder module configured to build a semantics graph that includes a relationship between each of the tags; and
a thematization module configured to cluster the semantics graph into themes.

12. The system of claim 11, wherein the thematization module is further configured to:
coarsen the semantics graph by iteratively finding a matching semantics graph with matching nodes, and collapsing each set of matched nodes into one node;
partition the coarsened graph by computing an edge-cut bisection of the coarsened graph such that each part of the bisection contains a reduced number of edge weights of the semantics graph; and
project the partitioned graph back to the semantics graph.

13. The system of claim 11, wherein the tag extractor module is further configured to identify at least one of a focus word and focus phrase via pattern recognition.

14. The system of claim 11, further comprising a computation module configured to compute a minimum number of web links to reach from a seed page to each corpus page on which the number of words appears.

15. The system of claim 14, further comprising deducing to which business line of a company each of the number of words is most related.
